(19) United States
(12) Patent Application Publication
(10) Pub. No.: US 2025/0013936 A1
(43) Pub. Date: Jan. 9, 2025

(54) FIELD OPERATIONS FRAMEWORK

(71) Applicant: Schlumberger Technology Corporation, Sugar Land, TX (US)

(72) Inventors: Zheng Zhang, Palaiseau (FR); Tianjun Hou, Antony (FR); Daria Khvostichenko, Houston, TX (US); Josselin Kherroubi, Paris (FR)

(21) Appl. No.: 18/711,386

(22) PCT Filed: Nov. 21, 2022
(86) PCT No.: PCT/US2022/080251

§ 371 Date: May 17, 2024

Related U.S. Application Data
(60) Provisional application No. 63/264,320, filed on Nov. 19, 2021.

(51) Int. Cl. G06Q 10/04; G06F 40/205; G06Q 50/02

(52) U.S. Cl. CPC G06Q 10/04; G06F 40/205; G06Q 50/02

(57) ABSTRACT

A method can include receiving remarks associated with one or more field operations; processing the remarks for event detection using a dependency matcher and a machine learning model, where, responsive to the dependency matcher failing to detect an event, the processing implements the machine learning model to detect the event; and outputting at least the detected event.

### CROSS REFERENCE TO RELATED APPLICATION

This application claims priority to and the benefit of a U.S. Provisional Application having Ser. No. 63/264,320, filed 19 Nov. 2021, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations. In such an example, control may be based at least in part on characteristics of rock where drilling into such rock forms a borehole that can be completed to form a well to produce from a reservoir and/or to inject fluid into a reservoir. While hydrocarbon fluid reservoirs are mentioned as an example, a reservoir that includes water and brine may be assessed, for example, for one or more purposes such as, for example, carbon storage (e.g., sequestration), water production or storage, geothermal production or storage, metallic extraction from brine, etc.

### SUMMARY

A method can include receiving remarks associated with one or more field operations; processing the remarks for event detection using a dependency matcher and a machine learning model, where, responsive to the dependency matcher failing to detect an event, the processing implements the machine learning model to detect the event; and outputting at least the detected event. A system can include one or more processors; memory accessible to at least one of the one or more processors; processor-executable instructions stored in the memory and executable to instruct the system to: receive remarks associated with one or more field operations; perform processing of the remarks for event detection using a dependency matcher and a machine learning model, where, responsive to a failure of the dependency matcher to detect an event, the processing implements the machine learning model to detect the event; and output at least the detected event. One or more computer-readable storage media can include processor-executable instructions to instruct a computing system to: receive remarks associated with one or more field operations; perform processing of the remarks for event detection using a dependency matcher and a machine learning model, where, responsive to a failure of the dependency matcher to detect an event, the processing implements the machine learning model to detect the event; and output at least the detected event. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates an example of a system;

FIG. 3 illustrates an example of a drilling equipment and examples of borehole shapes;

FIG. 4 illustrates an example of a system;

FIG. 5 illustrates examples of graphical user interfaces;

FIG. 6 illustrates an example of a diagram;

FIG. 7 illustrates an example of a graphical user interface;

FIG. 8 illustrates an example of a diagram;

FIG. 9 illustrates an example of a system;

FIG. 10 illustrates an example of a hybrid system;

FIG. 11 illustrates an example of a graphical user interface;

FIG. 12 illustrates an example of a graphical user interface;

FIG. 13 illustrates an example of a graphical user interface;

FIG. 14 illustrates an example of a method and an example of a system; and

FIG. 15 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

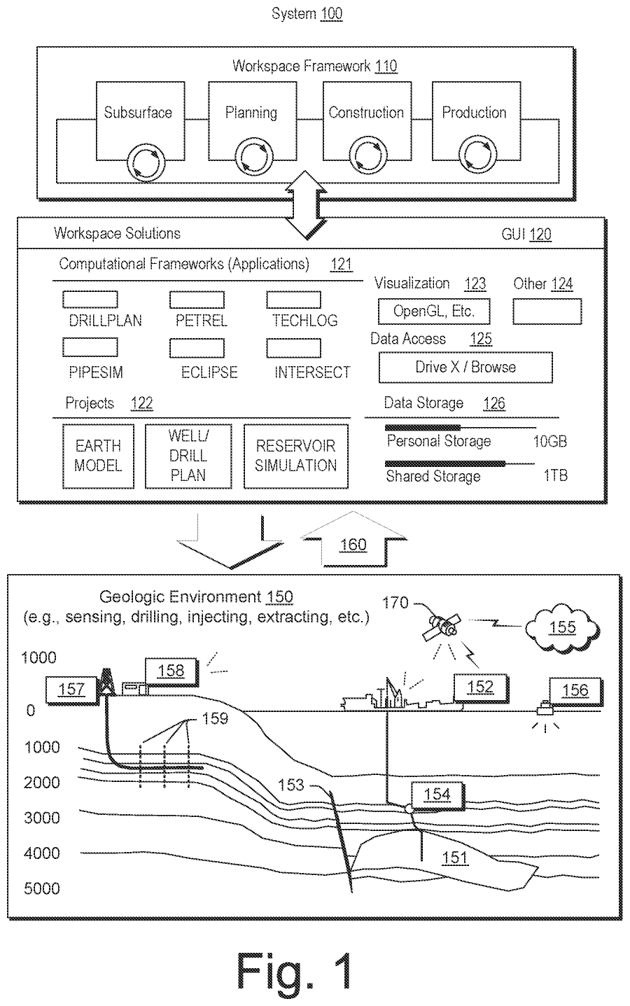

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. While several simulators are illustrated in the example of FIG. 1, one or more other simulators may be utilized, additionally or alternatively.

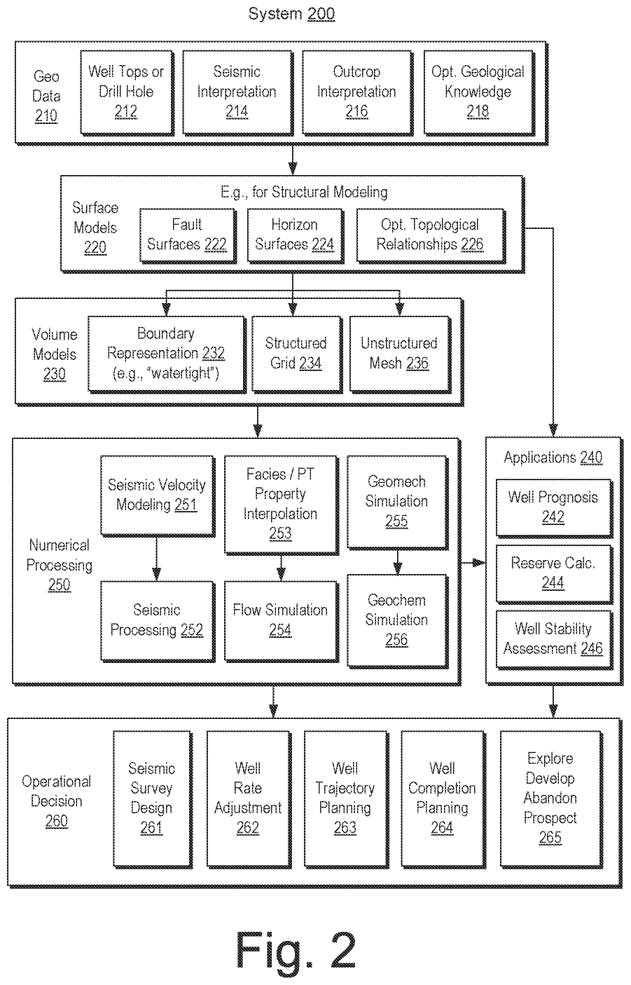

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, PETREL, TECHLOG, PIPESIM, ECLIPSE, INTERSECT, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

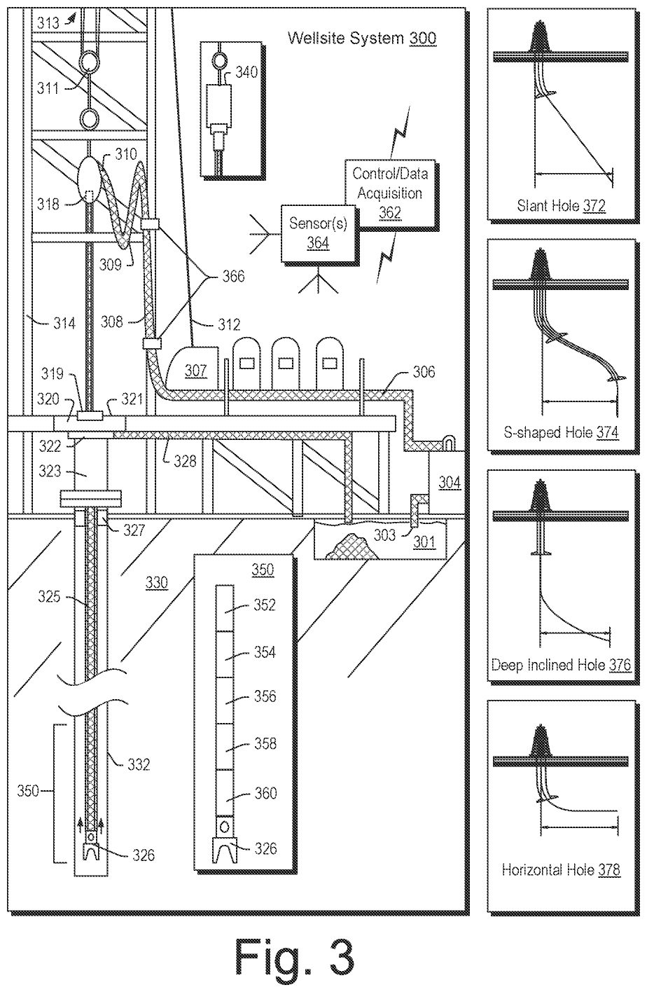

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud may be returned to the mud tank 301, for example, for recirculation with processing to remove cuttings and other material.

In the example of FIG. 3, processed mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry. Characteristics of the mud can be utilized to determine how pulses are transmitted (e.g., pulse shape, energy loss, transmission time, etc.).

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360, and the drill bit 326. Such components or modules may be referred to as tools where a drillstring can include a plurality of tools.

As to a RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

The LWD module 354 may be housed in a suitable type of drill collar and can contain one or a plurality of selected types of logging tools. It will also be understood that more than one LWD and/or MWD module can be employed, for example, as represented at by the module 356 of the drillstring assembly 350. Where the position of an LWD module is mentioned, as an example, it may refer to a module at the position of the LWD module 354, the module 356, etc. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD tool 354 may include equipment for generating electrical power, for example, to power various components of the drillstring 325. As an example, the MWD tool 354 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378.

A drilling operation can include directional drilling where, for example, at least a portion of a well includes a curved axis. For example, consider a radius that defines curvature where an inclination with regard to the vertical may vary until reaching an angle between approximately 30 degrees and approximately 60 degrees or, for example, an angle to approximately 90 degrees or possibly greater than approximately 90 degrees.

A directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As explained, a system may be a steerable system and may include equipment to perform a method such as geosteering. A steerable system can include equipment on a lower part of a drillstring which, just above a drill bit, a bent sub may be mounted. Above directional drilling equipment, a drillstring can include MWD equipment that provides real time or near real time data of interest (e.g., inclination, direction, pressure, temperature, real weight on the drill bit, torque stress, etc.) and/or LWD equipment. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment to follow a desired route to reach a desired target or targets.

A drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

Geosteering can include intentional directional control of a wellbore based on results of downhole geological logging measurements in a manner that aims to keep a directional wellbore within a desired region, zone (e.g., a pay zone), etc. Geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of approximately one hundred meters from the wellsite system 300.

The system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. Circuitry at the surface may include decoding circuitry to decode encoded information transmitted at least in part via mud-pulse telemetry. Circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

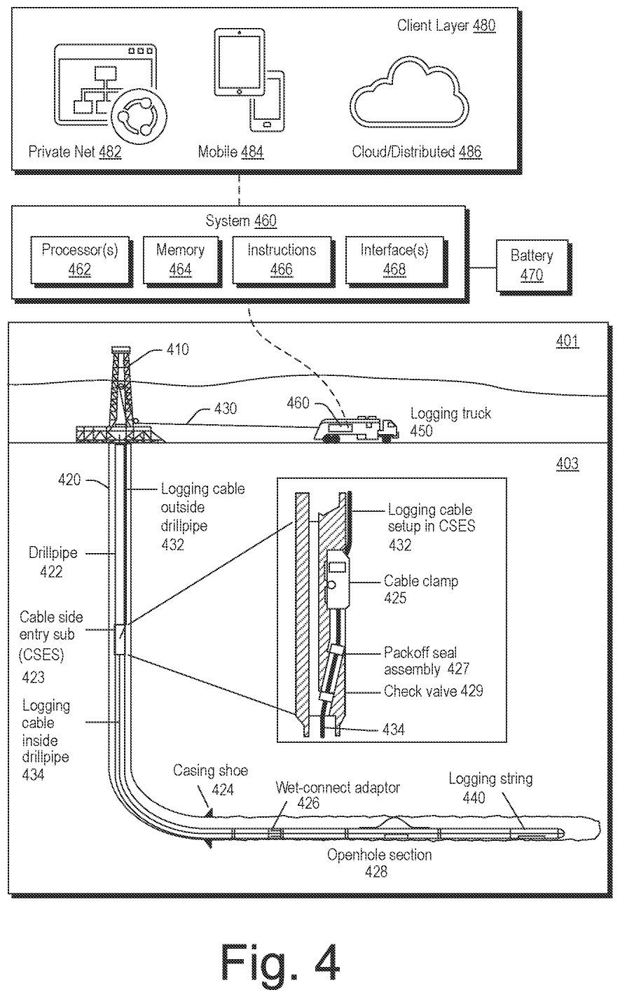

FIG. 4 shows an example of an environment 401 that includes a subterranean portion 403 where a rig 410 is positioned at a surface location above a bore 420. In the example of FIG. 4, various wirelines services equipment can be operated to perform one or more wirelines services including, for example, acquisition of data from one or more positions within the bore 420.

As an example, a wireline tool and/or a wireline service may provide for acquisition of data, analysis of data, data-based determinations, data-based decision making, etc. Some examples of wireline data can include gamma ray (GR), spontaneous potential (SP), caliper (CALI), shallow resistivity (LLS and ILD), deep resistivity (LLD and ILD), density (RHOB), neutron porosity (BPHI or TNPH or NPHI), sonic (DT), photoelectric (PEF), permittivity and conductivity.

In the example of FIG. 4, the bore 420 includes drillpipe 422, a casing shoe 424, a cable side entry sub (CSES) 423, a wet-connector adaptor 426 and an openhole section 428. As an example, the bore 420 can be a vertical bore or a deviated bore where one or more portions of the bore may be vertical and one or more portions of the bore may be deviated, including substantially horizontal.

In the example of FIG. 4, the CSES 423 includes a cable clamp 425, a packoff seal assembly 427 and a check valve 429. These components can provide for insertion of a logging cable 430 that includes a portion 432 that runs outside the drillpipe 422 to be inserted into the drillpipe 422 such that at least a portion 434 of the logging cable runs inside the drillpipe 422. In the example of FIG. 4, the logging cable 430 runs past the casing shoe 424 and the wet-connect adaptor 426 and into the openhole section 428 to a logging string 440.

As shown in the example of FIG. 4, a logging truck 450 (e.g., a wirelines services vehicle) can deploy the wireline 430 under control of a system 460. As shown in the example of FIG. 4, the system 460 can include one or more processors 462, memory 464 operatively coupled to at least one of the one or more processors 462, instructions 466 that can be, for example, stored in the memory 464, and one or more interfaces 468. As an example, the system 460 can include one or more processor-readable media that include processor-executable instructions executable by at least one of the one or more processors 462 to cause the system 460 to control one or more aspects of equipment of the logging string 440 and/or the logging truck 450. In such an example, the memory 464 can be or include the one or more processor-readable media where the processor-executable instructions can be or include instructions. As an example, a processor-readable medium can be a computer-readable storage medium that is not a signal and that is not a carrier wave.

FIG. 4 also shows a battery 470 that may be operatively coupled to the system 460, for example, to power the system 460. As an example, the battery 470 may be a back-up battery that operates when another power supply is unavailable for powering the system 460 (e.g., via a generator of the wirelines truck 450, a separate generator, a power line, etc.). As an example, the battery 470 may be operatively coupled to a network, which may be a cloud network. As an example, the battery 470 can include smart battery circuitry and may be operatively coupled to one or more pieces of equipment via a SMBus or other type of bus.

As an example, the system 460 can be operatively coupled to a client layer 480. In the example of FIG. 4, the client layer 480 can include features that allow for access and interactions via one or more private networks 482, one or more mobile platforms and/or mobile networks 484 and via the “cloud” 486, which may be considered to include distributed equipment that forms a network such as a network of networks. As an example, the system 460 can include circuitry to establish a plurality of connections (e.g., sessions). As an example, connections may be via one or more types of networks. As an example, connections may be client-server types of connections where the system 460 operates as a server in a client-server architecture. For example, clients may log-in to the system 460 where multiple clients may be handled, optionally simultaneously.

While the example of FIG. 4 shows the system 460 as being associated with the logging truck 450, one or more features of the system 460 may be included in a downhole assembly, which may be a wireline assembly and/or a LWD assembly. In such an approach, various computations may be performed downhole where results thereof may be optionally transmitted to surface (e.g., to the logging truck 450, etc.) using one or more telemetric technologies and/or techniques (e.g., mud-pulse telemetry, wireline, etc.).

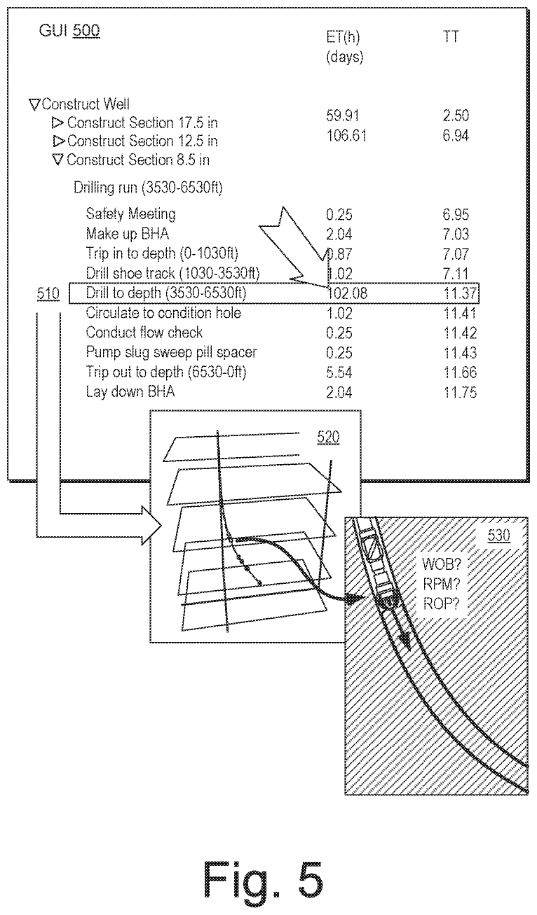

FIG. 5 shows an example of a graphical user interface 500 that includes various types of information for construction of a well where times are rendered for corresponding actions. In the example of FIG. 5, the times are shown as an estimated time (ET) in hours and a total or cumulative time (TT), which is in days. Another time may be a clean time, which can be for performing an action or actions without occurrence of non-productive time (NPT) while the estimated time (ET) can include NPT, which may be determined using one or more databases, probabilistic analysis, etc. In the example of FIG. 5, the total time (TT or cumulative time) may be a sum of the estimated time column. As an example, during execution and/or replanning the GUI 500 may be rendered and revised accordingly to reflect changes. As shown in the example of FIG. 5, the GUI 500 can include selectable elements and/or highlightable elements. As an example, an element may be highlighted responsive to a signal that indicates that an activity is currently being performed, is staged, is to be revised, etc. For example, a color coding scheme may be utilized to convey information to a user via the GUI 500.

As to the highlighted element 510 (“Drill to depth (3530-6530 ft)”) the estimated time is 102.08 hours, which is greater than four days. For the drilling run for the 8.5 inch section of the borehole, the highlighted element 510 is the longest in terms of estimated time. FIG. 5 also shows a GUI 520 for a borehole trajectory and a GUI 530 of a drillstring with a drill bit where drilling may proceed according to a weight on bit (WOB) and a rotational speed (RPM) to achieve a rate of penetration (ROP). In the example of FIG. 5, the GUI 530 and parameters thereof may be associated with drill bit performance (e.g., ROP, wear, remaining life, etc.).

As an example, the GUI 530 may be operatively coupled to an equipment framework (EF) such that, for example, variations in RPM and/or WOB can be visualized with respect to drill bit performance, which may provide for optimizations, control, etc. As an example, an ROP may be associated with wear where an optimal ROP may be an ROP that considers wear (e.g., in relationship to a depth to be drilled, etc.).

As an example, the GUI 500 can be operatively coupled to one or more systems that can assist and/or control one or more drilling operations. For example, consider a system that generates rate of penetration values, which may be, for example, rate of penetration set points. Such a system may be an automation assisted system and/or a control system. For example, a system may render a GUI that displays one or more generated rate of penetration values and/or a system may issue one or more commands to one or more pieces of equipment to cause operation thereof at a generated rate of penetration (e.g., per a WOB, a RPM, etc.). As an example, a time estimate may be given for the drill to depth operation using manual, automated and/or semi-automated drilling. For example, where a driller enters a sequence of modes, the time estimate may be based on that sequence; whereas, for an automated approach, a sequence can be generated (e.g., an estimated automated sequence, a recommended estimated sequence, etc.) with a corresponding time estimate. In such an approach, a driller may compare the sequences and select one or the other or, for example, generate a hybrid sequence (e.g., part manual and part automated, etc.).

As an example, a framework environment can include an option for execution of a framework that may run in the background, foreground or both. For example, consider executing the DRILLPLAN framework in the example system 100 of FIG. 1 where an equipment framework (EF) can be optionally instantiated for foreground and/or background execution that can assess information of the DRILLPLAN framework with respect to equipment choices, drilling fluid system choices, etc. In such an example, the equipment framework (EF) may act in response by making suggestions and/or changes.

While various operations with respect to drilling are mentioned in the example of FIG. 5, one or more other types of field operations may be organized in a manner with respect to one or more of depth and time. For example, consider logging operations that may utilize one or more wireline tools (see, e.g., FIG. 4).

Various aspects of various types of field operations can be recorded in the form of reports, which may be, for example, single operation reports, daily reports, weekly reports, monthly reports, etc., where frequency may depend on type of field operation. For example, one or more of the operations described with respect to FIG. 1, FIG. 2, FIG. 3, FIG. 4 and FIG. 5 may be accompanied by remarks that can be recorded, for example, on paper, digitally using a framework, etc. Remarks can include valuable information that may be utilized in one or more manners. For example, consider utilization of information included in remarks in combination with one or more of the frameworks of the system 100 of FIG. 1, the system 200 of FIG. 2, the wellsite system 300 of FIG. 3, the system 460 of FIG. 4, the GUI 500 of FIG. 5, etc. As an example, a hybrid system may be utilized for event detection in remarks where one or more detected events can be directed to a framework, a system, etc., optionally in real-time or near real-time.

As to drilling, remarks can be recorded in daily drilling reports (DDR) and daily mud reports (DMR), which can provide valuable information for analysis of ongoing operations and planning of one or more future operations (e.g., future wells, etc.). Such remarks may be entered as free text and thus represent unstructured information. For example, during one or more field operations set forth in the GUI 500 of FIG. 5, remarks may be generated and stored in a digital format. In the example of FIG. 5, the GUI 530 may provide one or more control instructions that may be based on one or more detected events in remarks for one or more field operations. In such an example, drilling can be improved, whether the remarks are for a well being drilled, another well being drilled, a well being planned, etc.

As to interpretation of remarks, which may be provided as information in reports, the remarks may be written using one or more types of language domains where interpretation is performed by a domain expert (e.g., an individual skilled in the domain). As an example, a framework can include a hybrid system that can expedite processing of remarks such that reliance on a domain expert can be reduced.

As an example, a framework can provide for interpretation of reports (e.g., remarks) in an automated manner, for example, with reduced reliance on one or more domain experts. For example, such a framework may utilize input from one or more domain experts during a rule-building phase for a rule-based model and/or a pre-training phase and/or a training phase for a machine learning model (ML model) where, once the rule-based model is built and/or the ML model is trained, the framework can operate in an automated manner to interpret one or more reports for one or more purposes. For example, consider interpretation of one or more reports for purposes of event detection, where an event may be a type of event that is not planned (e.g., an undesirable event). As an example, an unplanned event may contribute to NPT, increased expenditure of resource, etc. As context of an event may be known or discernable from various types of data, etc., detection of an unplanned event in context may be useful information for purposes of control, planning, training a ML model, etc.

As an example, a method can include generating a trained machine learning model to automatically detect events of interest and convert this information into a structured format. In the context of drilling, a trial involved several unscheduled events, such as losses, influx and stuck pipe, that were selected to develop an operation framework that included use of a natural language processing (NLP) approach for interpretation of daily DMR remarks. Various examples of aspects of data selection, data annotation and analysis workflows, and results, are described herein.

In a drilling operation, multiple types of data are collected. Many data streams tend to be in the form of numerical measurements that span a wide range of sampling frequencies, from Hz (e.g., equipment sensors, logging tools) to once in several hours (e.g., drilling fluid property measurements). These data can be recorded in a structured time series or depth-based format, which can be amenable for further analytics. A distinct type of data stream can be a free text data stream for describing daily operations (e.g., daily reports). An example of a document containing such a summary may be a DDR or a DMR. Such a summary includes a narrative of events with rich information that can be used for analyzing and adjusting an ongoing operation, planning new well construction projects, etc.

As an example, a daily comment may be as follows: Directionally drilled/slide from 12,258′ to 12,376′ where we changed out a bad swab; Circulated on one pump while changing and drilled ahead after swab change out; Encountered gas influx of 7, 100 units at 12,565′ and weighted mud up from 10.3 to 10.5 PPG; Monitoring gas units while directionally drilling/sliding; and Current depth of 12,631′ at time of report. Such a daily comment may also include, for example: Event: Gas influx.

Daily summaries (daily remarks) may contain information on unscheduled events, such as fluid losses, gas/water influx, stuck pipe, and information on lithology. Such information can be valuable under various circumstances, for example, if associated measurements are not available, as can happen, for example, when a service company is operating with other service providers at the rigsite and does not have any form of post-job access to other data. The free text nature of remarks, however, represents a considerable challenge for content extraction. For example, the same event can be described several ways, imposing additional complexity on content extraction.

As an example, one or more natural language processing (NLP) techniques may be employed to free text. For example, consider a method for event detection from free text daily remarks that can implement one or more NLP techniques.

In an example, a workflow considered a set (corpus) of remarks from DMRs collected over several years where the number of remarks was over 120,000, which would be prohibitively time-consuming to interpret manually (e.g., by domain experts). In the example, the workflow aimed to provide for event detection in the corpus where detected events may be utilized for drilling fluids operations, planning, control, ML model training, etc. In particular, several specific types of events were targeted, such as, stuck pipe, lost circulation, and water and gas (H2S) influx.

As an example, a workflow can include receiving data recorded using a fit-for-purpose application that generates DMRs for transmission by email to relevant parties, where such data can be loaded into a relational database (e.g., for ease of retrieval). One or more NLP techniques and/or one or more other techniques can be applied to the data corpus retrieved from the database, for example, to focus in on one or more types of events such as, for example, stuck pipe, lost circulation, water influx, and gas influx. In such an example, daily remarks can be retrieved from a centralized relational database that includes data from several thousand wells drilled in recent years; noting that processed structured data can be merged with other well attributes (e.g., location, depth, etc.). Such a workflow can provide for generation of data sufficient for supervised learning to train one or more ML models.

A challenge to automated event detection in remarks in DMRs and/or other types of reports can be the lack of an annotated dataset for use as labeled training data for supervised learning. As an example, a hybrid NLP technique can be implemented to help address such a challenge. For example, consider use of a rule-based model for identifying specific events where the identified specific events can be considered labeled training data for use in training a ML model. In such an example, the labeled training data from the rule-based model may supplement additional labeled training data. Once the ML model is trained, it may be utilized for purposes of event detection in unlabeled data (e.g., remarks that have not been annotated by a domain expert). As an example, an ML model may be part of a weakly-supervised training workflow that can generate so-called pseudo-documents for purposes of training in a manner with a reduced amount of labeled training data. As an example, a workflow can include, for training, using a rule-based model to enlarge a labeled training data and followed by training of a weakly-supervised text classification (WESTCLASS) model based on the enlarged training set. Once an ML model is trained, a framework may implement a hybrid approach that utilizes a rule-based approach in combination with an ML model-based approach for event detection. In such an example, where the rule-based model does not perform well on some cases, cases where no event is detected by the rule-based model can be input into the trained ML model for final event assignment.

As an example, a workflow can include text preprocessing, use of a dependency matcher, and use of a weakly-supervised learning model, and optionally use of an interactive improvement loop.

As to text preprocessing, it can aim to clean a training corpus before feeding it into an NLP model. In general, the cleaner the input data corpus, the better the result from the subsequent model application. As an example, text preprocessing can include processes such as, for example: sentence segmentation, splitting a document into sentences; tokenization, splitting sentences into smaller units such as individual words and terms; stop words removal, removing words that are commonly used in all corpus; lower case, converting all the words to the lower case; and stemming and lemmatization, replacing words to their root form.

As an example, a workflow can apply sentence segmentation, tokenization, and lower case to a corpus, for example, without using stop words removal, stemming and lemmatization in preprocessing as a dependency matcher can analyze sentence syntax and grammar internally. Further, in such an example, an additional preprocess can be specific to remarks of a type or types of reports (e.g., DDR, DMR, etc.). For example, a workflow can include defining a dictionary of terminologies, acronyms, and common misspellings where such a dictionary can be used to replace matching words with predefined standard spellings.

As to a dependency matcher, for various reports from field operations, a dependency matcher can provide for improved results over use of so-called regular expressions (regex). Regex uses a pattern that describes a text string for content extraction, which provides for simplicity of implementation. However, regex can have a number of drawbacks. To overcome drawbacks of regex, a rule-based model and a ML model can be utilized for content extraction.

As to some specific disadvantages of regex, consider unintuitive syntax. Unlike natural languages, regular expressions are not intuitive. To learn the syntax of a regular expression, a substantial number of rules and metacharacters are required. For example, consider a regular expression example that can be used in the mud loss value extraction task: .*?\bbbl.*?\blos|\blos.*?\bbbl.*?. The foregoing example is for a simple case, and it is already hard to understand especially for people who are not familiar with its syntax. When a regular expression gets more complicated, it becomes quite difficult for others to comprehend.

As to another specific disadvantage of regex, consider inefficiencies for multiple words matching. Most of the mud drilling-related event patterns contain more than one word to match. There are two options for multiple words matching using regular expressions, neither of them is efficient: (1) match each word separately, then get the intersection of the matching results, which is inefficient because of the multiple regular expressions executed; and (2) list the combinations of word order in one regular expression; as to one example of the regular expression matching “word_A” and “word_B”: \bword_A\b.*\bword_B\b/\bword_B\b.*\bword_A\b. In regex, the number of word order combinations increases exponentially with the number of words.

Yet another specific disadvantage is that regex does not support syntactic analysis for remarks. For example, consider the keywords “lose circulation” used in the lost circulation event detection as an example, “lose” has word forms such as “loses” and “losing” occurring in different mud drilling remarks. To cover these cases, regex explicitly requires a list of the word forms in one regular expression. Further, “lose circulation” do not always appear together in a sentence. As regular expressions do not support syntactic analysis, there is no way to search “lose” and “circulation” connected by a syntactic dependency in a sentence.

To address regex-based issues, as an example, a framework can implement a dependency-based event detector that leverages NLP for remarks (e.g., DMR, DDR, etc.), which can be more intuitive, robust, and powerful compared with regular expressions. As a dependency-based event detect can still belong to a category of rule-based methods, it can retain aspects of efficiency and interpretability as with regex-based methods.

As an example, a method can utilize a dependency parser that can analyze the grammatical structure of a sentence, establishing relationships between “head” words and words that modify those head words.

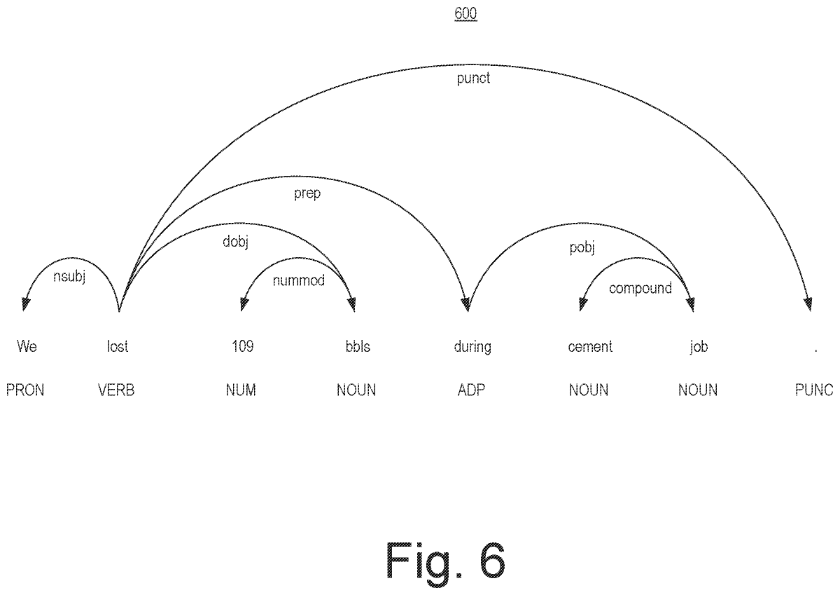

FIG. 6 shows an example of a diagram 600 as to dependencies generated by a dependency parser that can receive text, parse the text and generate appropriate dependencies between parts of the text. In the example of FIG. 6, the text is for a sentence: We lost 109 bbls during cement job. In the diagram 600, an arrow from the word “lost” to the word “bbls” indicates that “bbls” modifies the word lost, and a label dobj (direct object) is assigned to the arrow to describe the type of the dependency. A direct object is a noun phrase denoting a person or thing that is a recipient of an action of a transitive verb, for example, consider “the dog” in a sentence: Jimmy fed the dog. The diagram 600 also shows noun subject (nsubj), preposition (prep), prepositional object (pobj) (e.g., a noun phrase governed by a preposition), compound, number modifier (nummod), and punctuation (punct). As to the word “during”, it is a preposition that can be used before a noun (e.g., during+noun) to indicate when something happens. Accordingly, a dependency parser can include features to identify temporal relationships. As to the word “during”, it is also identified as an adposition (ADP), which is a cover term for prepositions and postpositions. Adpositions belong to a closed set of items that occur before (preposition) or after (postposition) a complement composed of a noun phrase, noun, pronoun, or clause that functions as a noun phrase, and that form a single structure with the complement to express its grammatical and semantic relation to another unit within a clause.

As an example, a dependency parser can utilize one or more types of parts of speech (POS) tags. For example, consider use of the universal POS tags that can be used to mark core POS categories. Such universal POS tags include open class word tags and closed class word tags. As to open class word tags, consider use of one or more of the following: ADJ (adjective), ADV (adverb), INTJ (interjection), NOUN (noun), PROPN (proper noun), and VERB (verb). As to closed class word tags, consider use of one or more of the following: ADP, AUX (auxiliary), CCONJ (coordinating conjunction), DET (determiner), NUM (number or numeral), PART (particle), PRON (pronoun), and SCONJ (subordinating conjunction). As to some examples of other tags, consider one or more of: PUNCT (punctuation), SYM (symbol), and X (other).

As an example, for each event of a field operation, a dependency parser can generate a dependency-based pattern, which may be from a number of defined dependency-based patterns. For example, a dependency parser may operate using a number of pre-defined types of dependency-based patterns, which may be extensible and/or otherwise modifiable, optionally in a manner that depends on the type of field operation. As an example, a pattern can consists of a list of head words, a list of modifying words, and a number of dependency link types. Such patterns can be used to match remarks. For example, a dependency matcher can use patterns to match remarks recorded in association with one or more field operations.

As explained, dependency patterns can be defined to describe a grammatical relationship between two words. As an example, a dependency pattern can include: a head word, a dependent word, and a dependency link. In such an example, the head word and the dependent word are specified by word level attributes, such as LOWER (the lowercase form of the word), POS (the word's POS tag), LEMMA (e.g., the lexeme form of the word), etc., and the dependency link is detailed by at least a grammatical relationship between the head word and the dependent word, as they may appear in a sentence. For example, as to the sentence of the diagram 600 of FIG. 6, a dependency pattern can be defined as: Head word: (LEMMA: lose); Dependent word: (LOWER: bbls, bbl); and Dependency link:-. In such an example, “(LEMMA: lose)” matches the words having the same word form as “lose”, such as lost, loses, losing, etc. As for the dependent word, “(LOWER: bbls, bbl)”, it matches the words having the same lowercase form of “bbls” or “bbl”. As indicated, a dependency link can have at least one direction, which can be, for example, from a head word to a dependent word.

As explained, a dependency approach can utilize features to handle text such as “lose circulation” as may be part of a lost circulation event remark where “lose” can be associated with word forms such as “loses” and “losing”, which may occur in different mud drilling remarks. As explained, the lexeme form of a word may be utilized to handle such types of text, for example, without having to explicitly list the word forms in one regular expression. Further, a system can handle text such as “lose circulation” when it does not appear as a contiguous phrase in a sentence. In contrast, as regular expressions do not support syntactic analysis, a regular expressions approach does not provide a way to search for “lose” and “circulation” connected by a syntactic dependency in a sentence.

As explained, daily summaries (e.g., daily remarks) may contain information on unscheduled events, such as fluid losses, gas/water influx, stuck pipe and information on formation names, mineralogy, and formation tops. Such information can be valuable for future use. As explained, a framework can provide for event detection from free text remarks using one or more NLP techniques where remarks can be matched regarding corresponding dependency patterns for different events. In such an example, one or more detected events can be passed to a discriminator that can apply one or more discrimination functions, for example, to exclude negation and (unhappened) forecasting cases (e.g., possible future scenarios described in a remark).

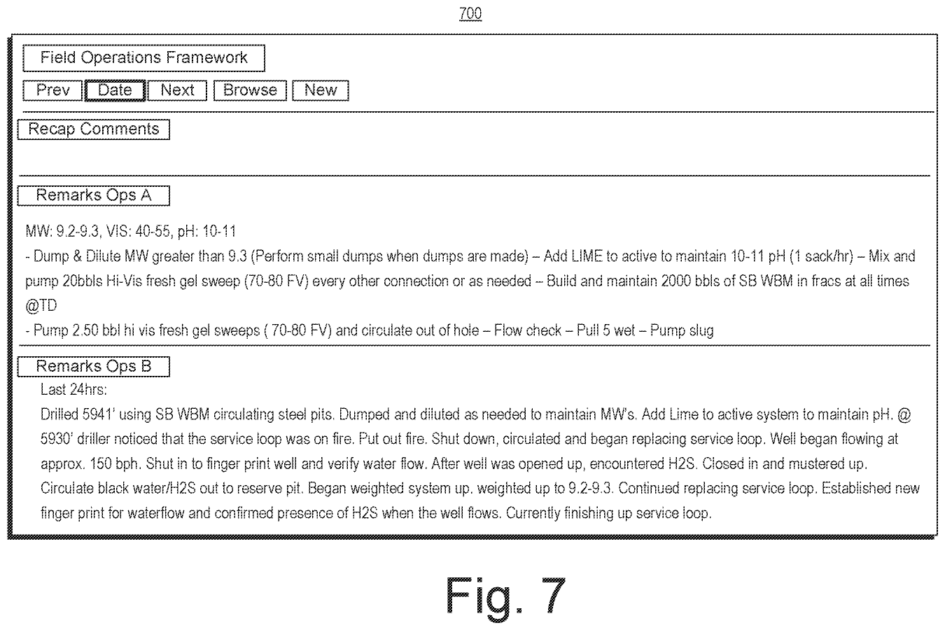

FIG. 7 shows an example of a graphical user interface (GUI) 700 that can be generated using an application, which may be a drilling framework application. As shown, the GUI 700 includes various fields for entry of text, which may be in a free form. During one or more field operations, a user may enter text into one or more of the fields where the text can be saved to memory, which may be local and/or remote (e.g., cloud-based, etc.).

As explained, designing and managing drilling fluid (mud) can be field operations used in well construction. Drilling fluids can function to provide sufficient hydrostatic pressure to prevent formation fluid from entering into a wellbore, function to cool a drill bit, function to clean a drill bit during drilling, function to carry out drill cuttings from a wellbore, and function to suspend drilling while drilling is paused. Before drilling commences, one or more drilling fluid engineers can determine type, volume and composition of drilling fluid. During the drilling, one or more engineers may monitor various aspects of drilling fluid (e.g., flowrate, pressure, etc.), at a wellsite to ensure a drilling operation performs as expected.

As explained, a report can include various remarks as to conditions, activities, etc. For example, one or more engineers can record remarks to generate a mud report on a daily basis. In addition to daily comments, such a report can include one or more types of metadata, which may be connected to one or more remarks. For example, consider index data, well location data (e.g., country, latitude/longitude), well name (e.g., ID), date, fluid system data, present activity data (e.g., event that happened during the working day), and drilling depth data (e.g., depth of drilling at the end of the working day).

As an example, a framework may consider various types of events as associated with “present activity” for purposes of content extraction, which can include unscheduled events and/or specific lithology types. Such events can be useful in planning one or more drilling fluid operations. As explained, a framework can provide for event detection, which can be performed by a dependency-based event detector, which may be utilized for extracting various types of events; noting that while drilling fluid is mentioned, such a framework may be applied to one or more other types of field operation remarks.

As to some types of events, consider lost circulation, water influx, H2S, and stuck pipe as types of unscheduled events; whereas, for example, anhydrite may be considered lithology and/or formation information. As an example, a framework may be operable to detect such types of events and/or lithology and/or formation information from remarks.

As explained, a dependency-based event detection framework can include a matching part and a discrimination part. In such an example, for each event, one or more dependency patterns can be defined, for example, based on domain knowledge (see, e.g., the diagram 600 of FIG. 6). After matching, one or more matched remarks can be processed by a discriminator that utilized one or more discrimination functions, for example, consider one or more functions to exclude negation and/or one or more functions to exclude (unhappened) forecasting cases. For example, remarks containing “seepage loss” can have a relatively high likelihood of being a “lost circulation” event. However, if a sentence is “ . . . not a seepage loss . . . ” (negation) or “next 24h: . . . seepage loss . . . ” (forecasting), then a framework can exclude such remarks such that they are not classified as a lost circulation event. A discrimination function may vary by event type as different event-related remarks may have different ways for negation and/or forecasting expressions.

As explained, in a dependency-based approach, dependency patterns can be defined intuitively. In various examples, patterns can be explicitly defined using words. For multiple words cases, dependency patterns can support assigning multiple values to attributes of a head word and a dependent word; noting that multiple attributes can be supported. For example, “(POS: VERB)” can be added to a head word indicating that the POS of the head word is also a verb. As an example, dependency patterns can be based on syntactic structures in a manner that leverages one or more NLP techniques for more robust and powerful event detection.

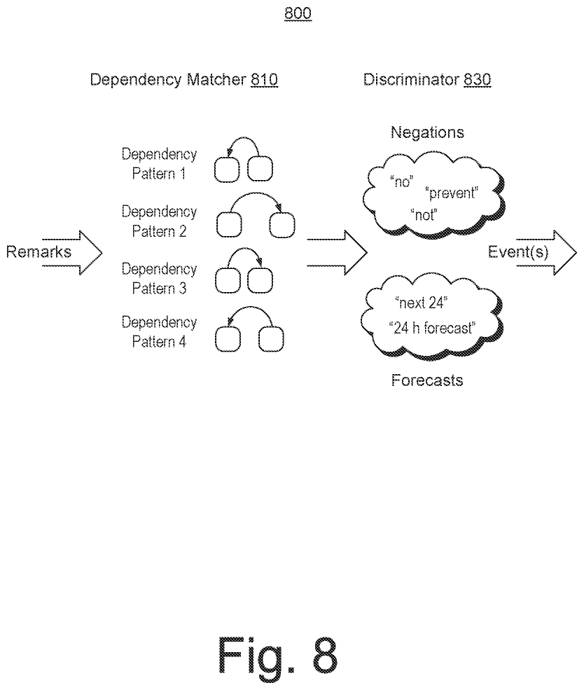

FIG. 8 shows an example of an event detector 800 that can perform event detection via a dependency matcher 810 followed by application of a discriminator 830. As shown, the dependency matcher 810 can utilize patterns where the discriminator 830 uses rules to exclude negations and rules to exclude forecasts. For example, negations such as “no”, “prevent”, and “not” and probabilistic terms such as “possible” may be identified for purposes of exclusion as to an event affirmatively not occurring or an event not being confirmed (e.g., less than 50 percent chance that it occurred) and forecasting terms (e.g., temporal terms) such as “next 24” and “24 hour forecast” may be identified for purposes of exclusion. As explained, a report can include text that may be entered by one or more users where such text may include one or more negations and/or one or more forecasts. As explained, a discriminator can handle such real-world realities of reports, where negations and/or forecasts may be valuable information, however, not necessarily relevant for detection of one or more events.

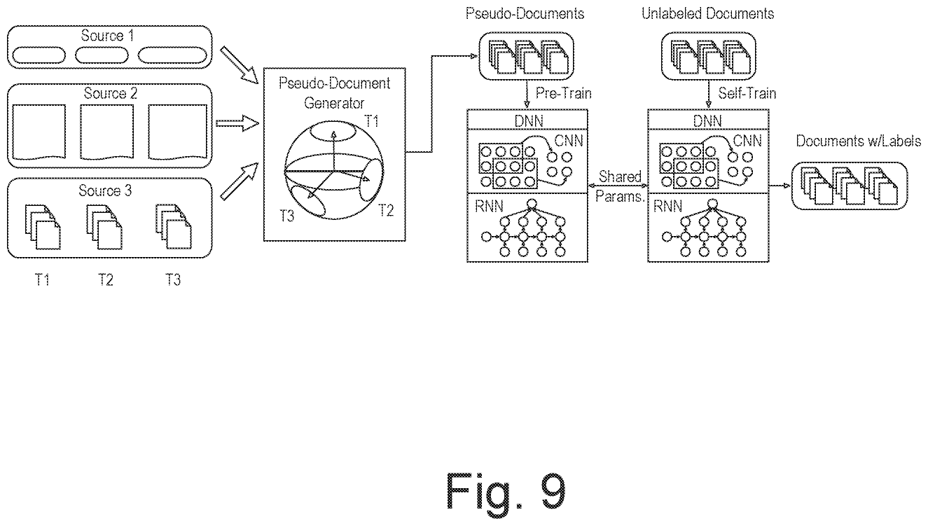

FIG. 9 shows an example of a system 900 that may be utilized to generate a sufficient amount of labeled data to train a supervised ML model for purposes of event detection. For example, consider a method that can apply a dependency matcher to unlabeled remarks and expand a labeled training data set with the remarks having events detected by the dependency matcher. In such an example, the method can then apply a weakly-supervised learning model to the extended labeled data.

In the example of FIG. 9, the system 900 can be a weakly-supervised text classification (WESTCLASS) system, for example, as in an article by Meng et al., “Weakly-Supervised Neural Text Classification”, The 27th ACM International Conference on Information and Knowledge Management (CIKM 18), Torino, Italy (2018), which is incorporated by reference herein. In the system 900, various sources are indicated as Source 1, Source 2 and Source 3, along with topics T1, T2 and T3. As an example, a system may be suitable for handling one or more sources and one or more topics.

As shown in FIG. 9, the system 900 can include a pseudo-document generator that leverages seed information to generate pseudo-labeled documents for model pre-training, and a self-training component that bootstraps on unlabeled data for model refinement. As an example, a model can accept different resources such as, for example, label surface names, class-related keywords, and labeled documents.

As an example, a method can include inputting labeled remarks into the system 900 as labeled documents. In such an example, instead of directly using the labeled documents as training data for one or more deep neural network models (DNN models) for a classification task, the system 900 can generate pseudo-documents based on keywords extracted from the given labeled data. The system 900 can be particularly useful for scenarios with relatively small sets of labeled training data.

As shown in the example of FIG. 9, the pseudo-document generator can leverages seed information from one or more sources to generate pseudo-documents as synthesized training data. In such an example, by assuming word and document representations reside in a common semantic space, the system 900 can generate pseudo-documents for each class by modeling the semantics of each class as a high-dimensional spherical distribution where further sampling of keywords can be performed to form pseudo-documents. In such an example, the pseudo-document generator can expand user-given seed information for better generalization and also handle different types of seed information (e.g., label surface names, class-related keywords, a few labeled documents, etc.) flexibly.

As shown in the example of FIG. 9, the self-training component can fit real unlabeled documents for model refinement. In such an approach, the self-training component can use pseudo-documents to pre-train CNN-based and/or RNN-based models to produce an initial model, which can serve as a starting point in a subsequent model refining process. The system 900 can apply a self-training procedure to iteratively make predictions on real unlabeled documents and leverages high confidence predictions to refine the model (or models).

In the example of FIG. 9, the system 900 is shown as including one or more convolution neural networks (CNNs) and/or one or more recurrent neural networks (RNNs). CNNs are regularized versions of multilayer perceptrons. Multilayer perceptrons usually mean fully connected networks, that is, each neuron in one layer is connected to all neurons in the next layer. The full connectivity of these networks makes them prone to overfitting data. Typical ways of regularization, or preventing overfitting, include: penalizing parameters during training (such as weight decay) or trimming connectivity (skipped connections, dropout, etc.). CNNs take a different approach towards regularization: they take advantage of the hierarchical pattern in data and assemble patterns of increasing complexity using smaller and simpler patterns embossed in their filters. Therefore, on a scale of connectivity and complexity, CNNs are on the lower extreme. As to RNNs, it is a class of artificial neural networks where connections between nodes can create a cycle, allowing output from some nodes to affect subsequent input to the same nodes. Such an approach allows an RNN to exhibit temporal dynamic behavior. Derived from feedforward neural networks, RNNs can use their internal state (memory) to process variable length sequences of inputs. RNNs can provide an infinite impulse response, whereas CNNs provide for finite impulse response. Both classes of networks can exhibit temporal dynamic behavior. A finite impulse recurrent network is a directed acyclic graph that can be unrolled and replaced with a strictly feedforward neural network, while an infinite impulse recurrent network is a directed cyclic graph that cannot be unrolled. Both finite impulse and infinite impulse recurrent networks can have additional stored states, and the storage can be under direct control by the neural network. The storage can also be replaced by another network or graph if that incorporates time delays or has feedback loops. Such controlled states can be referred to as gated state or gated memory, and can be part of long short-term memory networks (LSTMs) and gated recurrent units.

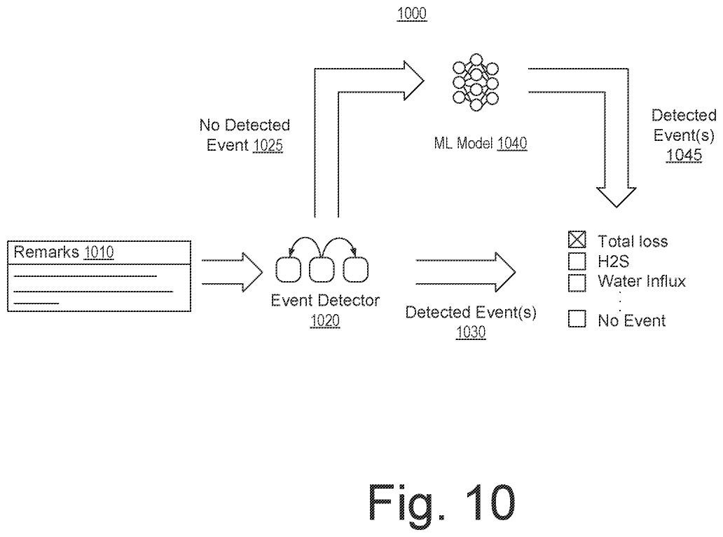

FIG. 10 shows an example of a hybrid system 1000 that can be amenable to user feedback collection. As shown, the hybrid system 1000 can provide for event detection in remarks 1010 via an event detector 1020 and an ML model 1040 where, for example, the event detector 1020 can include a dependency matcher-powered rule-based model (see, e.g., the event detector 800 of FIG. 8) and where, for example, the machine learning model 1040 can include a WESTCLASS-based deep learning model (see, e.g., the system 900 of FIG. 9). As shown in the example of FIG. 10, the hybrid system 1000 can receive the remarks 1010 and process the remarks 1010 using the event detector 1020 where the event detector 1020 may or may not detect one or more events. As shown, where the event detector 1020 outputs no detected event 1025, the hybrid system 1000 progresses to the ML model 1040 for performing event detection for the remarks 1010. As an example, where the event detector 1020 does detect one or more events as one or more detected events 1030, the hybrid system 1000 can output such one or more events as one or more detected events.

As an example, the hybrid system 1000 may operate on a phrase-by-phrase basis, a sentence-by-sentence basis and/or other basis. For example, the remarks 1010 may be a set of remarks that pertain to a particular period of time for a particular type of field operation. In such an example, the set of remarks (an amount of text, etc.) can be expected to describe occurrence of an event or no occurrence of an event or, as explained, a possible forecast of an event. As to no occurrence of an event, the set of remarks may explicitly use a negation to indicate that a particular event did not occur, or, for example, there may be no indication of occurrence of a particular event. As explained, a discriminator can handle negations to exclude language as to an event not occurring and can also handle forecasts to exclude language as to some future possibility of an event occurring. As to the existence of remarks, for example, why they were written, a system may assume that they were written to describe some type of condition, scenario, etc. Hence, negation of an event may be an indication that conditions seemed like they were part of an event but proved otherwise and forecast of an event may be an indication that conditions seemed like they may possibly give rise to a future event. Thus, there can be a high likelihood that a set of remarks was written for a reason related to occurrence of an event, non-occurrence of an event or possible future occurrence of an event. Given such a likelihood, the hybrid system 1000 may expect that if the event detector 1020 does not detect an event (see no detected event 1025) that there may very well be an event described in a set of remarks and that the ML model 1040 can be implemented to suitable detect that event in the set of remarks. As an example, a method can include, responsive to a failure of the event detector 1020 to detect an event (see no detected event 1025), directing remarks to the ML model 1040 for purposes of event detection.

As an example, the hybrid system 1000 may operate in one or more modes. For example, consider a mode where the ML model 1040 is implemented for remarks regardless of event detection by the event detector 1020 and consider another mode where the ML model 1040 is implemented responsive to a failure of the event detector 1020 to detect an event. In such an example, the latter mode may be a more expedited mode of operation of the hybrid system 1000 as the ML model 1040 is implemented on as needed basis, rather than for each set of remarks regardless of output by the event detector 1020.

As explained, as the event detector 1020 can be relatively robust in event detection, upon detection of an event by the event detector 1020, the hybrid system 1000 may proceed to outputting the detected event, optionally without processing of a set of remarks by the ML model 1040. Such an approach may help to expedite processing of remarks for purposes of event detection.

In the example of FIG. 10, as to training, a method can include using a rule-based model to enlarge a labeled training data set and then training the WESTCLASS model based on the enlarged training set. For example, the event detector 1020 can be implemented for purposes of enlarging a labeled training data set where the enlarged labeled training data set can be utilized for training the ML model 1040.

As to inference, a method can first use a dependency matcher (e.g., the event detector 1020) to predict an event where, if an event is detected, the detected event can be used as a prediction of the hybrid system 1000. In contrast, if no event has been identified by the dependency matcher (e.g., the event detector 1020), then the particular remarks can be directed to a deep learning model (e.g., the ML model 1040) to generate a prediction.

As explained, a workflow can include a training phase and then an inference phase, where the inference phase can be an event detection phase that can process remarks for one or more events. As explained, a training phase may be performed using a rule-based approach and a WESTCLASS approach where such an approach may be efficient in that it can be performed with a reduced amount of labeled (e.g., annotated) training data (e.g., labeled or annotated remarks). In various approaches to deep learning, the amount of training data for suitable learning can be considerable where generating such an amount of training data can be time-consuming and resource intensive. The combination of a rule-based approach and a WESTCLASS approach can lessen demands for time and resources. As an example, a framework may include one or more features that can further improve a hybrid system. For example, consider a framework that can provide for rendering remarks and results (e.g., detected events) such that an individual can review and readily confirm or deny one or more of the results. In such an example, the individual's input may be considered feedback that can be utilized for training (e.g., re-training), for example, as a type of labeled data (e.g., what is an event in a remark and/or what is not an event in a remark).

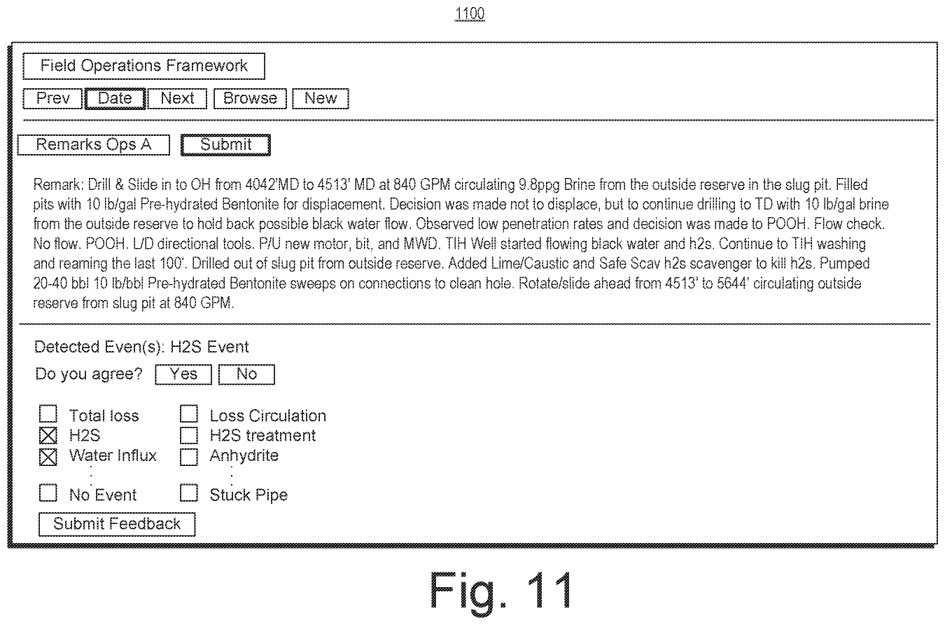

FIG. 11 shows an example of a graphical user interface (GUI) 1100 for interactive feedback collection that may be utilized to optimize a model. As shown in the example of FIG. 11, a user can enter and/or select remarks in a field of the GUI 1100 and actuate a “submit” graphical control (e.g., a button) to cause the system 1000 of FIG. 10 to generate detected events. As to the feedback submission option, by actuating a “yes” graphical control, a user can confirm that the one or more events are appropriately detected; otherwise, a list of potential events can be rendered and for selection of one or more of the events by the user as feedback (see, e.g., “submit feedback” graphical control). In such an example, input can be gathered and structured along with the corresponding remarks and detected events for further improvement of a model.

In an example run, 853 remarks out of a corpus of 128,328 remarks were annotated. A rule-based model was constructed using patterns based on keywords and word dependencies. In testing, the model performed well concerning precision but showed a somewhat low recall, where precision and recall can be computed as follows:

$$Precision = \frac{TP}{TP + FP} ; Recall = \frac{TP}{TP + FN}$$

where true positive TP stands for the number of remarks with correctly detected events; a false positive FP is a remark that the detected event is not correct; a false negative FN is a remark present in the annotated test set with the corresponding event but absent from the model predictions.

Example remarks A and B were considered, as set forth below:
Remark A: Detected event, Stuck pipe, Desired event, Stuck pipe
   Drilled to 5605′, drilling had slowed down and was decided to POOH to change bit. While starting to POOH, the hole was tight. Started getting stuck, washed several stands out to 4761′, Started to Pull and Jar on stands. As of time of report, still stuck and working on pipe. There are no returns due to possible packing off around drill pipe. Pipe is stuck at 4760′.
Remark B: Detected event Water influx Desired event No event
   Isolate casing and monitor casing pressure, Rig down and blow down cement line. Clean and clear rig floor, Service rig, Load shed with Drill pipe, Verify no pressure on 10.75″ casing. ND well control equipment Clean and clear cellar, N/U Adapter flange, and MPD equipment, N/U BOP stack, Rig up to test BOPs. Shell test stack.

As shown, a remark may include typographical errors, capitalization errors, etc. (e.g., two periods, a space before a period, various capital letters in the middle of sentences, etc.). A head word, dependent word and dependency link type of approach can appropriately handle various forms of text, which may include some typographical errors. Processing of remarks A and B demonstrated capabilities of the rule-based model. While the model successfully detected a stuck pipe event, it mistakenly assigned a remark with no event to the “water influx” class based on the presence of the “well control” word combination. Overall, the accuracy of the rule-based model on the test set decreased to approximately 65 percent.

As explained, a hybrid approach that utilizes a rule-based model and a ML model can improve accuracy compared to use of a rule-based model alone. As explained, a ML model can work in situations where a corpus of labeled training data tends to be quite small. For example, the ML model 1040 in the hybrid system 1000 can be trained with a set of labeled training data that may be small fraction of the amount of data required for some NLP techniques (e.g., consider 10 percent or less, 5 percent or less, 1 percent or less of a total corpus used for a NLP technique).

As explained with respect to the example system 900 of FIG. 9, a ML model can include a pseudo-document generator that leverages seed information to generate pseudo-labeled documents for ML model pre-training, and a self-training component that bootstraps on real unlabeled data for ML model refinement.

As an example, to provide robust event detection with a reduction in training data, a weakly-supervised text classification method can implement a pseudo-document generator that unifies seed information and outputs pseudo-documents for model training. In such an example, the method can assume words and documents share a joint semantic space which provides flexibility for handling different types of seed information. In such an example, the method can model each class as a high-dimensional spherical distribution from which keywords can be sampled to form pseudo documents as training data. Such training data can be utilized by the method for self-training as may be integrated into one or more deep neural models (e.g., CNN-based, RNN-based, etc.). For example, consider using the generated pseudo documents to pre-train one or more ML models, which allows for an ML model to start with a suitable initialization. Once initialized, a self-training procedure can be applied to iteratively refine the one or more ML models using unlabeled real documents based on high-confidence predictions.

In processing the remarks A and B using the hybrid system 1000 of FIG. 10, the issues identified as to the rule-based model alone were overcome. As explained, the hybrid system 1000 may use a rule-based model to label data and then use augmented labeled data to train a deep learning model for event detection. In various trials, the hybrid system 1000 increased event detection performance by more than 20 percentage points. As explained, the hybrid system 1000 may be operated in a manner whereby the ML model 1040 is utilized responsive to a failure of the event detector 1020 to detect an event. In such an implementation, the hybrid system 1000 may operate expeditiously to handle remarks that the event detector 1020 does not suitably handle.

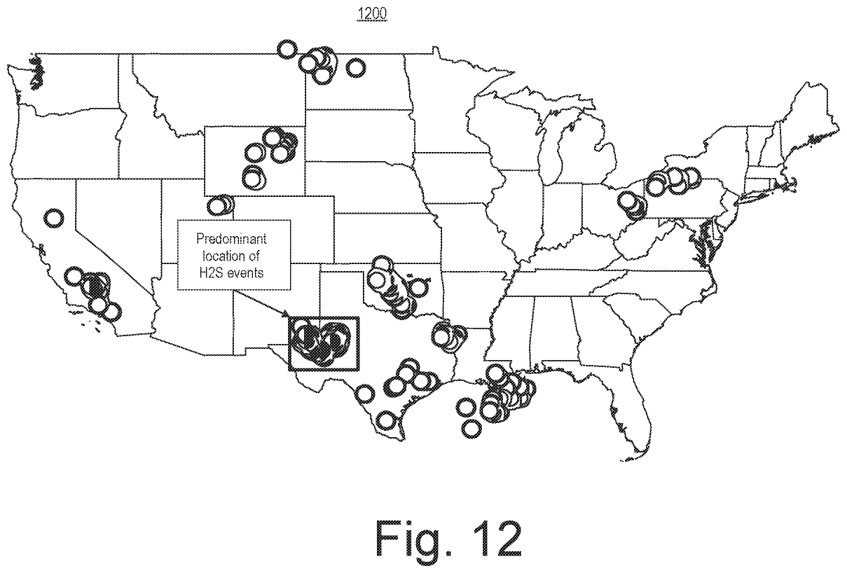

FIG. 12 shows an example of a graphical user interface (GUI) 1200 that includes a map with locations where the locations show information derived from a system such as the hybrid system 1000 of FIG. 10. As shown, through use of detected events and one or more other types of data (e.g., as may be stored in a relational database), further insight and/or analytics can be generated. In particular, in the GUI 1200, a region is highlighted that includes predominant locations of H2S events, where stuck pipe events are also shown.

As shown in the GUI 1200, in the lower 48 US states, H2S influx predominantly occurs in the Permian basin, whereas stuck pipe events can occur US-wide. The GUI 1200 shows an example of high-level information on the types of hazards present in various locations, allowing project engineer to preemptively plan for H2S and to help ensure that relevant chemicals are available on hand (e.g., via procurement and/or transport logistics) or being able to quickly identify stuck pipe occurrences and corresponding conditions to avoid undesirable events in wells, whether operational, being drilled, planned for future operations, etc. As an example, such information can be further combined with depth information in the DMR to obtain event distribution by depth.

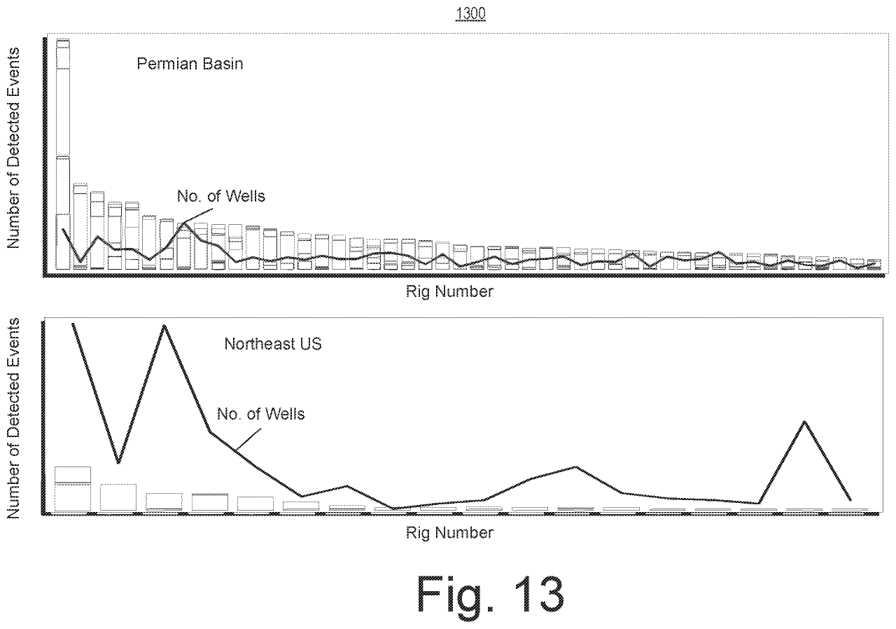

FIG. 13 shows an example of a graphical user interface (GUI) 1300 with event count distribution by rig in the Permian basin (top panel) and US Northeast (bottom panel). In the GUI 1300, a black line indicates the number of wells drilled by each rig and each stacked bar represents one rig. The bars shown in the GUI 1300 are stacks of different types of events. In the GUI 1300, results demonstrate that in addition to H2S (Permian Basin) there is a substantial number of occurrences of lost circulation in both basins, whereas in the Northeast the main type of unscheduled event is stuck pipe. The GUI 1300 also demonstrates that some rigs are more prone to certain kinds of events, and that it is not fully defined by the number of wells drilled by the rig. In the example GUI 1300, the divisions in the bars represent different categories from a group of categories, including: anhydrite, not anhydrite, gas influx, H2S, not H2S, H2S treatment, lost circulation, lost circulation-lost circulation material, stuck pipe, not stuck pipe, water influx and not water influx.

As explained, a hybrid system can provide for event detection, where, for example, output from a rule-based NLP model is additionally parsed by a weakly-supervised machine learning model. In various examples, a hybrid system automatically processed over 120,000 daily remarks and extracted information about a number of pre-defined events (e.g., stuck pipe, lost circulation, water influx, gas influx, H2S, etc.), noting that such a system can be utilized for one or more other types of reports, remarks, events, etc.

As explained, a hybrid system can be utilized to implement a workflow that can convert unstructured text data into structured event information. In combination with other well data stored in a structured format, such as location and daily depth, results can be used for one or more purposes, which can include one or more of well planning, offset well analysis, control, training one or more other ML models, etc. As an example, results may be utilized to train one or more ML models utilized in automated control for one or more field operations. For example, consider an automated driller that can perform automated drilling operations based at least in part on output from one or more ML models.

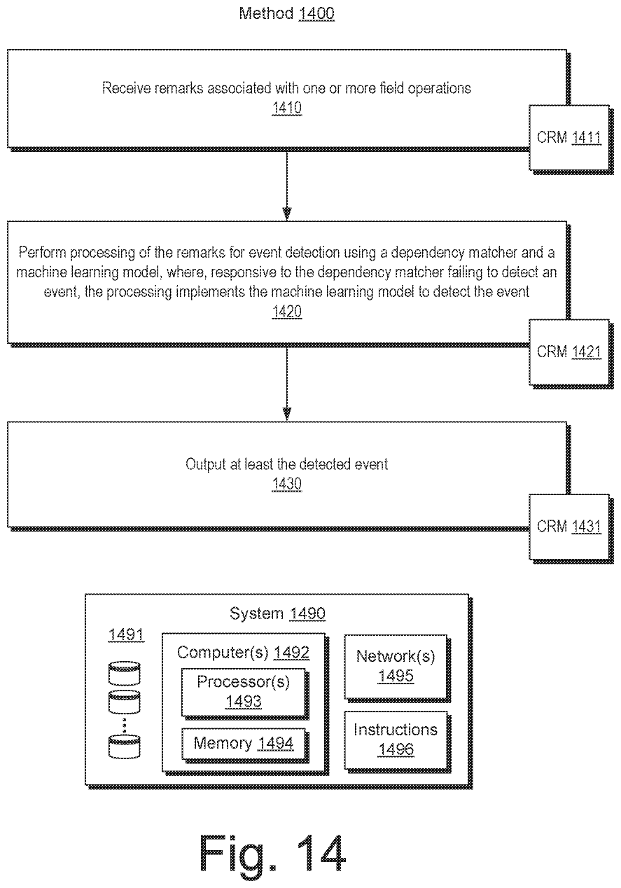

FIG. 14 shows an example of a method 1400 and an example of a system 1490. As shown, the method 1400 can include a reception block 1410 for receiving remarks associated with one or more field operations; a performance block 1420 for performing processing of the remarks for event detection using a dependency matcher and a machine learning model, where, responsive to the dependency matcher failing to detect an event, the processing implements the machine learning model to detect the event; and an output block 1430 for outputting at least the detected event.

The method 1400 is shown in FIG. 14 in association with various computer-readable media (CRM) blocks 1411, 1421 and 1431. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1400. As an example, a computer-readable medium (CRM) may be a computer-readable storage medium that is non-transitory and that is not a carrier wave. As an example, one or more of the blocks 1411, 1421 and 1431 may be in the form processor-executable instructions.

In the example of FIG. 14, the system 1490 includes one or more information storage devices 1491, one or more computers 1492, one or more networks 1495 and instructions 1496. As to the one or more computers 1492, each computer may include one or more processors (e.g., or processing cores) 1493 and memory 1494 for storing the instructions 1496, for example, executable by at least one of the one or more processors 1493 (see, e.g., the blocks 1411, 1421 and 1431). As an example, a computer may include one or more network interfaces (e.g., wired or wireless), one or more graphics cards, a display interface (e.g., wired or wireless), etc.

As to types of machine learning models that may be implemented for one or more purposes, which may include event detection, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley Al Research (BAIR) (University of California, Berkeley, California). As another example, consider the SCIKIT platform (e.g., scikit-learn), which utilizes the PYTHON programming language. As an example, a framework such as the APOLLO Al framework may be utilized (APOLLO.AI GmbH, Germany). As an example, a framework such as the PYTORCH framework may be utilized (Facebook Al Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

As an example, method can include receiving remarks associated with one or more field operations; processing the remarks for event detection using a dependency matcher and a machine learning model, where, responsive to the dependency matcher failing to detect an event, the processing implements the machine learning model to detect the event; and outputting at least the detected event. In such an example, the dependency matcher can include a discriminator that excludes one or more of negations and forecasts in the remarks. In such an example, the forecasts can pertain to possible occurrence of a future event recorded in the remarks, for example, using temporal language.

As an example, a dependency matcher can include a parser that parses phrases in remarks to generate a pattern. In such an example, the pattern can include a head word, a dependent word and a dependency link.

As an example, a dependency matcher can perform stemming and lemmatization. In such an example, the dependency matcher can use stemming and lemmatization to replace a word with its root form.

As an example, a machine learning model can include a deep neural network model. In such an example, the deep neural network model can include one or more of a convolution neural network model and a recurrent neural network model.

As an example, one or more field operations can include at least one oil and gas field operation. As an example, remarks can include drilling remarks and/or can include drilling fluid remarks.

As an example, a method can include rendering a graphical user interface to a display where the graphical user interface includes a remark and a detected event. In such an example, the method can include receiving input via the graphical user interface as feedback and can include training a machine learning model using the feedback.

As an example, a method can include adjusting at least one ongoing field operation based at least in part on a detected event. In such an example, the detected event can be or can include a stuck pipe event; noting that one or more other types of events may be detected events that can be utilized for adjusting at least one ongoing field operation.

As an example, a method can include planning at least one field operation based at least in part on a detected event. For example, consider planning an addition field operation for a well, which may be a well associated with the detected event or another well, which may be new or in the process of being drilled, completed, etc.

As an example, a method can include rendering a graphical user interface to a display where the graphical user interface includes at least one graphic that associates a detected event with one or more of a location and a rig.

As an example, a system can include one or more processors; memory accessible to at least one of the one or more processors; processor-executable instructions stored in the memory and executable to instruct the system to: receive remarks associated with one or more field operations; perform processing of the remarks for event detection using a dependency matcher and a machine learning model, where, responsive to a failure of the dependency matcher to detect an event, the processing implements the machine learning model to detect the event; and output at least the detected event.

As an example, one or more computer-readable storage media can include processor-executable instructions to instruct a computing system to: receive remarks associated with one or more field operations; perform processing of the remarks for event detection using a dependency matcher and a machine learning model, where, responsive to a failure of the dependency matcher to detect an event, the processing implements the machine learning model to detect the event; and output at least the detected event.

As an example, a computer program product can include one or more computer-readable storage media that can include processor-executable instructions to instruct a computing system to perform one or more methods and/or one or more portions of a method.

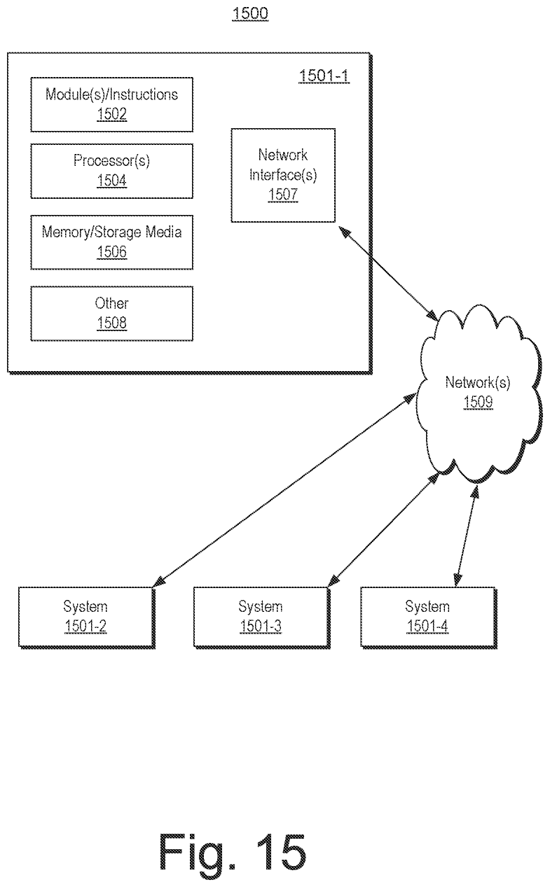

In some embodiments, a method or methods may be executed by a computing system. FIG. 15 shows an example of a system 1500 that can include one or more computing systems 1501-1, 1501-2, 1501-3 and 1501-4, which may be operatively coupled via one or more networks 1509, which may include wired and/or wireless networks.

As an example, a system can include an individual computer system or an arrangement of distributed computer systems. In the example of FIG. 15, the computer system 1501-1 can include one or more modules 1502, which may be or include processor-executable instructions, for example, executable to perform various tasks (e.g., receiving information, requesting information, processing information, simulation, outputting information, etc.).

As an example, a module may be executed independently, or in coordination with, one or more processors 1504, which is (or are) operatively coupled to one or more storage media 1506 (e.g., via wire, wirelessly, etc.). As an example, one or more of the one or more processors 1504 can be operatively coupled to at least one of one or more network interfaces 1507; noting that one or more other components 1508 may also be included. In such an example, the computer system 1501-1 can transmit and/or receive information, for example, via the one or more networks 1509 (e.g., consider one or more of the Internet, a private network, a cellular network, a satellite network, etc.).

As an example, the computer system 1501-1 may receive from and/or transmit information to one or more other devices, which may be or include, for example, one or more of the computer systems 1501-2, etc. A device may be located in a physical location that differs from that of the computer system 1501-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1406 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

Documents incorporated by reference herein:
David M. Blei, Andrew Y. Ng, and Michael I. Jordan. 2003. “Latent Dirichlet Allocation.” NIPS.
Hoffimann, Julio, Youli Mao, Avinash Wesley, and Aimee Taylor. 2018. “Sequence Mining and Pattern Analysis in Drilling Reports with Deep Natural Language Processing.” SPE Annual Technical Conference and Exhibition. Dallas, Texas.
Jared Ucherek, Tesleem Lawal, Matthew Prinz, Lisa Li, Pradeepkumar Ashok, and Eric van Oort. 2020. “Auto-Suggestive Real-Time Classification of Driller Memos into Activity Codes Using Natural Language Processing.” IADC/SPE International Drilling Conference and Exhibition. Galveston, Texas.
Jian Tang, Meng Qu, and Qiaozhu Mei. 2015. “PTE: Predictive Text Embedding through Large-scale Heterogeneous Text Networks.” KDD.
Keqian Li, Hanwen Zha, Yu Su, and Xifeng Yan. 2018. “Unsupervised Neural Categorization for Scientific Publications.” SDM.
Kim, Yoon. 2014. “Convolutional Neural Networks for Sentence Classification.” EMNLP.
Ming-Wei Chang, Lev-Arie Ratinov, Dan Roth, and Vivek Srikumar. 2008. “Importance of Semantic Representation: Dataless Classification.” AAAI.
Roth, Yangqiu Song and Dan. 2014. “On Dataless Hierarchical Text Classification.” AAAI.
Yu Meng, Jiaming Shen, Chao Zhang, Jiawei Han. 2018. “Weakly-Supervised Neural Text Classification.” The 27th ACM International Conference on Information and Knowledge Management (CIKM′ 18). Torino, Italy: ACM, New York, NY, USA. 10 pages.
Zichao Yang, Diyi Yang, Chris Dyer, Xiaodong He, Alexander J. Smola, and Eduard H. Hovy. 2016. “Hierarchical Attention Networks for Document Classification.” HLT-NAACL.

What is claimed is:

1. A method comprising:
receiving remarks associated with one or more field operations;
processing the remarks for event detection using a dependency matcher and a machine learning model, wherein, responsive to the dependency matcher failing to detect an event, the processing implements the machine learning model to detect the event; and
outputting at least the detected event.

2. The method of claim 1, wherein the dependency matcher comprises a discriminator that excludes one or more of negations and forecasts in the remarks.

3. The method of claim 2, wherein the forecasts pertain to possible occurrence of a future event recorded in the remarks using temporal language.

4. The method of claim 1, wherein the dependency matcher comprises a parser that parses phrases in the remarks to generate a pattern.

5. The method of claim 4, wherein the pattern comprises a head word, a dependent word and a dependency link.

6. The method of claim 1, wherein the dependency matcher performs stemming and lemmatization.

7. The method of claim 6, wherein the dependency matcher uses stemming and lemmatization to replace a word with its root form.

8. The method of claim 1, wherein the machine learning model comprises a deep neural network model.

9. The method of claim 8, wherein the deep neural network model comprises one or more of a convolution neural network model and a recurrent neural network model.

10. The method of claim 1, wherein the one or more field operations comprise at least one oil and gas field operation.

11. The method of claim 1, wherein the remarks comprise drilling remarks.

12. The method of claim 1, wherein the remarks comprise drilling fluid remarks.

13. The method of claim 1, comprising rendering a graphical user interface to a display, wherein the graphical user interface comprises a remark and the detected event.

14. The method of claim 13, comprising receiving input via the graphical user interface as feedback and comprising training the machine learning model using the feedback.

15. The method of claim 1, comprising adjusting at least one ongoing field operation based at least in part on the detected event.

16. The method of claim 15, wherein the detected event comprises a stuck pipe event.

17. The method of claim 1, comprising planning at least one field operation based at least in part on the detected event.

18. The method of claim 1, comprising rendering a graphical user interface to a display wherein the graphical user interface comprises at least one graphic that associates the detected event with one or more of a location and a rig.

19. A system comprising:
one or more processors;
memory accessible to at least one of the one or more processors;
processor-executable instructions stored in the memory and executable to instruct the system to:
receive remarks associated with one or more field operations;
perform processing of the remarks for event detection using a dependency matcher and a machine learning model, wherein responsive to a failure of the dependency matcher to detect an event, the processing implements the machine learning model to detect the event; and
output at least the detected event.

20. One or more computer-readable storage media comprising processor-executable instructions to instruct a computing system to:
receive remarks associated with one or more field operations;
perform processing of the remarks for event detection using a dependency matcher and a machine learning model, wherein responsive to a failure of the dependency matcher to detect an event, the processing implements the machine learning model to detect the event; and
output at least the detected event.
